(19) United States
(12) Patent Application Publication
(10) Pub. No.: US 2005/0062947 A1
(43) Pub. Date: Mar. 24, 2005

(54) Near-field exposure apparatus

(75) Inventor: Toshihiro Fuse, Kawasaki-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/936,792

(22) Filed: Sep. 9, 2004

(30) Foreign Application Priority Data
Sep. 12, 2003 (JP) 321594/2003(PAT.)

(51) Int. Cl. G03B 27/52

(52) U.S. Cl. 355/30; 355/53

(57) ABSTRACT

A near-field exposure apparatus includes an pressure adjusting vessel in which pressure is adjustable, mask supporting means for supporting an elastically deformable exposure mask to the pressure adjusting vessel, adjusting means for adjusting the pressure in the pressure adjusting vessel to bring the exposure mask into close contact with a substrate to be exposed to near-field light leaking from an opening provided in the exposure mask by irradiating the substrate with exposure light from a light source through the exposure mask, and on-off control means for controlling the mask supporting means. In the apparatus, a supporting force for supporting the exposure mask to the pressure adjusting vessel by the mask supporting means is resistant to a load created when the exposure mask is deformed by adjusting the pressure in the pressure adjusting vessel. Further, the mask supporting means is controlled by the on-off control means in an on-off control manner to permit the exposure mask to be mounted to and demounted from the pressure adjusting vessel.

### FIELD OF THE INVENTION AND RELATED ART

The present invention relates to a near-field exposure apparatus for effecting light exposure by bringing a mask into close contact with a resist to a near-field area.

Increasing capacity of a semiconductor memory and increasing speed and density of a CPU processor have inevitably necessitated further improvements in fineness of microprocessing through optical lithography. Generally, the limit of microprocessing with an optical lithographic apparatus is of an order of the wavelength of light used. Thus, the wavelength of light used in optical lithographic apparatuses has been shortened more and more. Currently, near ultraviolet laser is used, and microprocessing of 0.1 μm order is enabled. While the fineness is being improved in the optical lithography, in order to assure microprocessing of 0.1 μm or narrower, there still remain many unsolved problems such as further shortening of wavelength of laser light, development of lenses usable in such wavelength region, and the like.

On the other hand, as a means for enabling microprocessing of 0.1 μm or narrower, a microprocessing apparatus using a structure of a near-field optical microscope (scanning near-field optical microscope: SNOM), has been proposed. An example is an exposure apparatus in which, one or more processing probes are employed and by use of near-field light leaking from a fine opening of a size not greater than 100 nm, local exposure that exceeds the light wavelength limit is performed to a resist.

In such a light exposure using near-field light, as an exposure method for improving the throughput, e.g., U.S. Pat. No. 6,171,730 proposes a close contact exposure method using near-field light in which a thin film mask having a pattern arranged so that near-field light leaks from a light blocking film, is exposed to light by being closely contacted to a resist upon a substrate to such an extent that a distance therebetween is not more than 100 nm in the near-field area, whereby a fine pattern of the photomask is transferred to the photoresist at once.

In the above described close contact exposure method using near-field light, as described above, it is necessary to bring the thin film mask in close contact with the resist on the substrate to such an extent that a distance therebetween is not more than 100 nm in the near-field area during the light exposure. As a close contact method for that purpose, it has been considered to employ methods including one wherein a thin film mask supported so as to face the inside of a pressure adjusting vessel capable of being pressurized at its surface on a light source side is deformed by applying thereto a certain pressure with fluid in the pressure adjusting vessel to be closely contacted to a resist disposed outside the pressure adjusting vessel and one wherein a thin film mask supported so as to face the outside of a pressure adjusting vessel capable of being reduced in pressure at its surface on a light source side is closedly contacted to a resist disposed in the pressure adjusting vessel by causing a negative pressure in the pressure adjusting vessel. These methods may appropriately be selected depending on conditions with respect to an apparatus structure, a thin film specification, etc. However, in these methods, further improvements have been desired with respect to problems, such as a pressure loss in the pressure adjusting vessel during the exposure to light by the exposure apparatuses used, and workability and cost of the exposure mask during mounting thereof to the exposure apparatuses and demounting thereof from the exposure apparatuses.

### SUMMARY OF THE INVENTION

An object of the present invention is to provide a near-field exposure apparatus capable of minimizing a pressure loss in a pressure adjusting vessel during close contact exposure with a near-field exposure mask.

Another object of the present invention is to provide a near-field exposure apparatus which provides good workability during mounting of the near-field exposure mask to the apparatus and demounting thereof from the apparatus.

According to the present invention, there is provided a near-field exposure apparatus, comprising:
an pressure adjusting vessel in which pressure is adjustable,
mask supporting means for supporting an elastically deformable exposure mask to the pressure adjusting vessel,
adjusting means for adjusting the pressure in the pressure adjusting vessel to bring the exposure mask into close contact with a substrate to be exposed to near-field light leaking from an opening provided in the exposure mask by irradiating the substrate with exposure light from a light source through the exposure mask, and
on-off control means for controlling the mask supporting means,
wherein a supporting force for supporting the exposure mask to the pressure adjusting vessel by the mask supporting means is resistant to a load created when the exposure mask is deformed by adjusting the pressure in the pressure adjusting vessel, and the mask supporting means is controlled by the on-off control means in an on-off control manner to permit the exposure mask to be mounted to and demounted from the pressure adjusting vessel.

In the above described apparatus, the mask supporting means may preferably support the exposure mask by bringing a portion adjacent to the exposure mask into close contact with the supporting means. Further, the supporting means may preferably support the portion adjacent to vacuum chuck the exposure mask so that the exposure mask is elastically deformable at its center portion.

In the above described apparatus, the supporting means may preferably comprise a vacuum chuck. The vacuum chuck may preferably support the exposure mask by disposing a sealing member between the exposure mask and the vacuum chuck. The vacuum chuck may also preferably be provided with a groove for supporting the exposure mask to the vacuum chuck by evacuating a portion therebetween.

In the above described apparatus, the supporting means may preferably comprise a magnet or an electrostatic adsorption member. Further, the exposure mask may preferably have a surface, located on the light source side, being disposed to face an inside or an outside of the pressure adjusting vessel.

In the present invention, the exposure mask is mounted to and demounted from the pressure adjusting vessel by on-off control of the supporting means, thus being subjected to mounting and demounting in a short time.

Herein, “on-off control” refers to on-off control of a switch provided or connected to the supporting means so as to control actuation of an actuating portion of the supporting means. More specifically, the on-off control includes on-off control of a vacuum pump connected to the vacuum chuck and on-off control of an electrostatic chuck switch, a magnet chuck switch, etc.

Further, according to the present invention, it becomes possible to minimize a pressure loss in the pressure adjusting vessel during close contact exposure with the near-field exposure mask. In addition, good workability can be achieved when the exposure mask is mounted to and demounted from the exposure apparatus, thus realizing an excellent near-field exposure apparatus.

Further, in the present invention, a sealing structure can be provided by engaging an O-ring in an O-ring groove formed in the mask supporting means, thus minimizing a fluctuation of pressure in the pressure adjusting vessel.

The above described sealing Structure for preventing leakage of reduced pressure may be such a structure that the supporting means for supporting the near-field exposure mask to the pressure adjusting vessel is sealed by a polished surface. By using such a simple structure utilizing the polished surface, it becomes possible to suppress a fluctuation in pressure in the pressure adjusting vessel. Further, by using the simple structure in combination with the sealing structure described above, it is possible to further suppress the fluctuation in pressure in the pressure adjusting vessel.

Further, it is also possible to provide such a structure that the exposure mask is integrally supported and fixed with the mask supporting means to the pressure adjusting vessel.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic view showing a structure of a near-field exposure apparatus, including a pressure adjusting vessel capable of being pressurized, in Embodiment 1 of the present invention.

FIG. 2 is a schematic view showing a structure of a near-field exposure apparatus, including a pressure adjusting vessel capable of being depressurized, in Embodiment 1 of the present invention.

FIG. 3 is a schematic view showing a vacuum type mask supporting and fixing structure in Embodiment 1 of the present invention.

FIG. 4 is a schematic view showing a magnet type mask supporting and fixing structure in Embodiment 1 of the present invention.

FIG. 5 is a schematic view showing an electrostatic mask supporting and fixing structure in Embodiment 1 of the present invention.

FIG. 6 is a schematic view showing a circular structure of a vacuum chuck surface in Embodiment 1 of the present invention.

FIG. 7 is a schematic view showing a rectangular structure of a vacuum chuck surface in Embodiment 1 of the present invention.

FIG. 8 is a schematic view showing a sealing state of a mask with a gasket comprising a supporting means of a resin etc., in Embodiment 1 of the present invention.

FIGS. 9(a) and 9(b) are schematic views showing a structure of a mask with a gasket comprising a supporting means of a resin etc., in Embodiment 1 of the present invention, wherein FIG. 9(a) is a plan view and FIG. 9(b) is a sectional view along A-A line.

FIGS. 10(a) and 10(b) are schematic views showing a structure of a mask with a gasket comprising a supporting means of a resin etc., in Embodiment of the present invention, wherein FIG. 10(a) is a plan view and FIG. 10(b) is a sectional view along B-B line.

FIG. 11 is a schematic view showing a sealing state of a mask with a gasket comprising a supporting means of a metal, in Embodiment 1 of the present invention.

FIGS. 12(a) and 12(b) are schematic views showing a structure of a mask with a gasket comprising a supporting means of a metal, in Embodiment 1 of the present invention, wherein FIG. 12(a) is a plan view and FIG. 12(b) is a sectional view along A-A line.

FIGS. 13(a) and 13(b) are schematic views showing a structure of a mask with a gasket comprising a supporting means of a metal, in Embodiment of the present invention, wherein FIG. 13(a) is a plan view and FIG. 13(b) is a sectional view along B-B line.

FIG. 14 is a schematic view showing a structure of a vacuum chuck in Embodiment 2 of the present invention.

FIG. 15 is a schematic view showing a structure of a vacuum chuck in Embodiment 3 of the present invention.

FIG. 16 is a schematic view showing a supporting and fixing structure of a near-field exposure mask in Embodiment 4 of the present invention.

### DETAILED DESCRIPTION OF THE PREFERRED EMBODIMENTS

The present invention will be described more specifically based on Embodiments shown below.

[Embodiment 1]

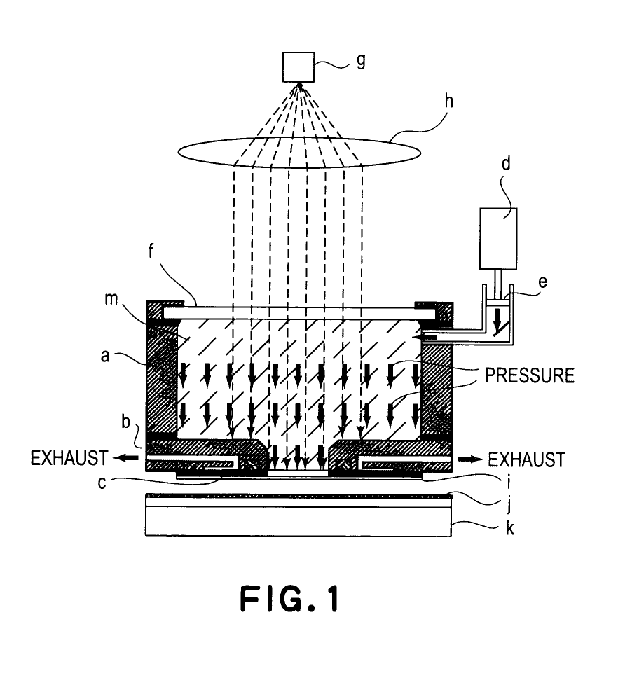

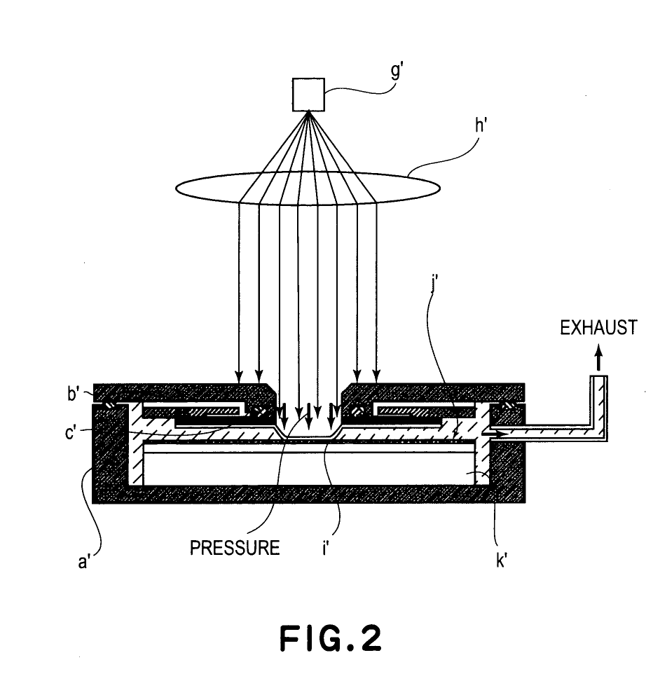

FIG. 1 is a conceptual view illustrating a structure of a near-field exposure apparatus including a pressure adjusting vessel capable of being increased in pressure, in Embodiment 1 of the present invention. FIG. 2 is a conceptual view illustrating a structure of a near-field exposure apparatus including a pressure adjusting vessel capable of being decreased in pressure, in Embodiment 1 of the present invention.

First, a general structure of the near-field exposure apparatus, including the pressure adjusting vessel capable of being pressurized, shown in FIG. 1 will be described.

The system shown in FIG. 1 includes a pressure adjusting vessel a, a mask chuck b, an O-ring c, a piston-type drive motor d, a piston e, a glass window f, a light source g, a lens h, a mask i, a resist surface j of a substrate to be exposed to light, and a stage k.

In the near-field exposure apparatus shown in FIG. 1, the mask i is supported by the mask chuck b so that the surface of the mask on the light source g side faces the inside of the pressure adjusting vessel a. When the mask i is closely contacted to the resist surface j of the substrate to be exposed to light during light exposure, a fluid m is pressurized in the pressure adjusting vessel a while controlling an amount of movement of the piston e by the motor d to bring the mask i into close contact with the resist surface j of the substrate, to be exposed to light, disposed on the stage k outside the pressure adjusting vessel a.

Next, a general structure of the near-field exposure apparatus, including the pressure adjusting vessel capable of being depressurized, shown in FIG. 2 will be described.

The system shown in FIG. 2 includes a pressure adjusting vessel a′, a mask chuck b′, an O-ring c′, a light source g′, a lens h′, a mask i′, a resist surface j′ of a substrate to be exposed to light, and a stage k′.

In the near-field exposure apparatus shown in FIG. 2, the mask I′ is supported by the mask chuck B′ so that the surface of the mask on the light source G′ side faces the outside of the pressure adjusting vessel a′. When the mask I′ is closely contacted to the resist surface j′ of the substrate to be exposed to light during light exposure, the inside of the pressure adjusting vessel a′ is reduced in pressure while effecting evacuation to bring the mask i′ into close contact with the resist surface j′ of the substrate, to be exposed to light, disposed on the stage k′ inside the pressure adjusting vessel a′.

Then, a supporting and fixing structure for the mask when the mask is mounted (attached) to and demounted (removed) from the near-field exposure apparatus will be described with reference to FIG. 1.

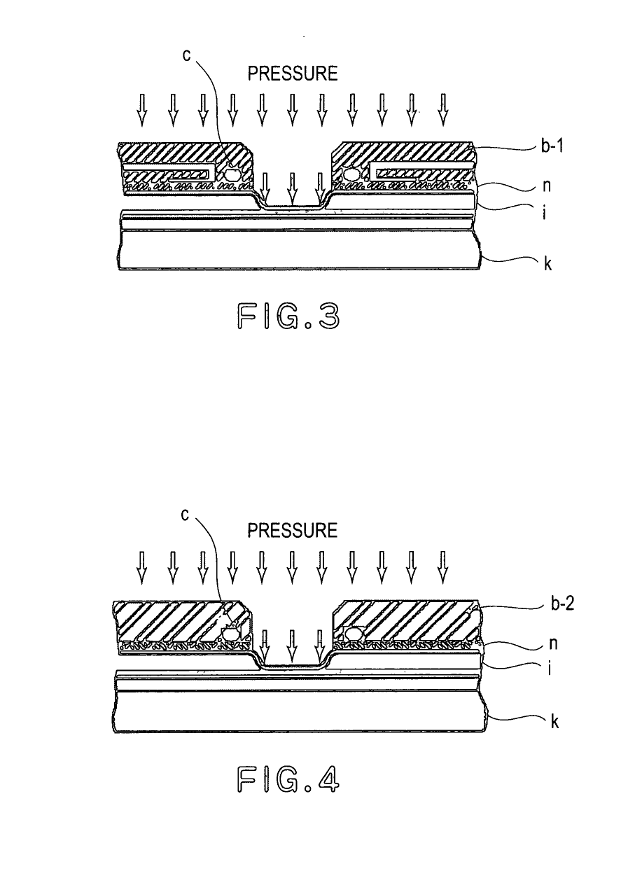

A vacuum-type mask supporting and fixing structure as shown in FIG. 3, as an example of the supporting and fixing structure for the mask i is provided at the surface of the mask chuck b of the pressure adjusting vessel a shown in FIG. 1. In this case, the mask i is relatively positionally aligned with the substrate to be exposed to light as desired.

Referring to FIG. 3, the structure includes a vacuum chuck b-1 as the mask chuck b shown in FIG. 1, a mask support n, a mask i similar to that shown in FIG. 1, and a stage k similar to that shown in FIG. 1.

In the vacuum-type supporting and fixing structure, the vacuum chuck b-1 formed in the pressure adjusting vessel a is designed so that it adsorbs the mask i by vacuuming through evaluation from the evacuation portion (as shown in FIG. 1). The vacuum chuck b-1 provides a vacuum (adsorption) force which is resistant to a deformation pressure required for ensuring functioning of the O-ring used or a gasket member described later, a weight of the mask, and a pressure (about 10-70 Pa as experimental data) for deforming a thin film pattern portion of the mask by fluid pressure to bring the mask into close contact with the resist surface.

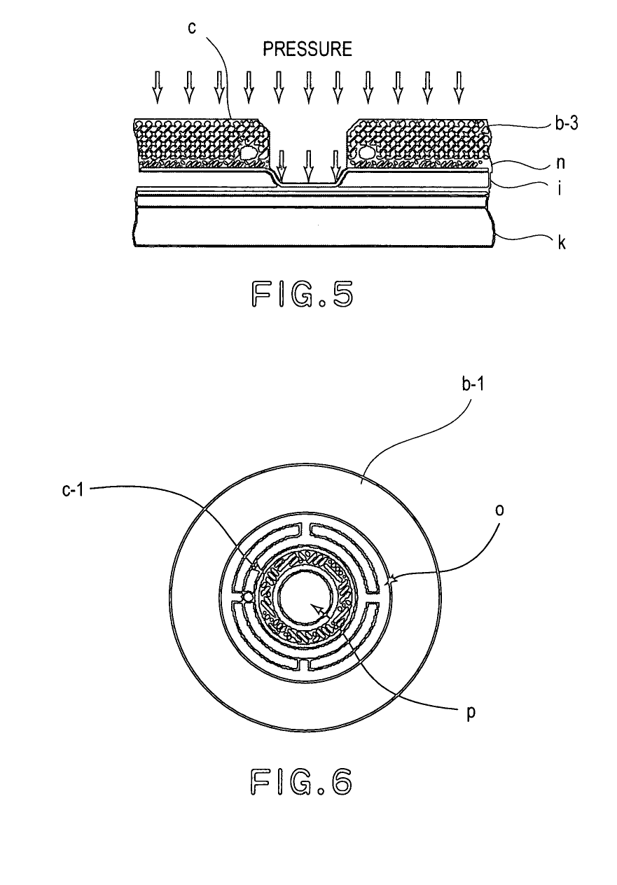

FIGS. 6 and 7 are views each showing a specific structure at the surface of the vacuum chuck in the above described vacuum-type supporting and fixing structure.

In each of FIGS. 6 and 7, the structure includes an O-ring mounting groove c-1 and a vacuum groove o formed at the vacuum chuck surface. The vacuum groove o may have any shape, depending on the mask shape, such as a circular shape shown in FIG. 6, a rectangular (square) shape or other shapes. In this regard, a state of the vacuum chuck surface is important. More specifically, a magnitude of the vacuum force is changed depending on conductance even in the case of the same groove shape, so that it is necessary to effect estimation in advance.

In this embodiment, a mask substrate which has a size of 38.1 mm×25.4 mm, a thickness of 0.525 mm, and a surface roughness of not more than 0.2 μm, is used.

A thin film mask having a size of 10 mm×10 mm is disposed on the substrate at the center thereof. On the other hand, the vacuum chuck is formed of a SUS 304 material and has a polished surface which has been polished under a surface processing condition of not more than 3.2S (according to JIS B0601) in terms of surface roughness. It is confirmed that there is no warp of the vacuum chuck.

On the base of the above described conditions, the shape of the polished surface with the surface roughness is assumed that it is averagely tube shape having a diameter of 3 μm and is molded. Then, an amount of leakage is estimated according to the following equation (1) for the conductance C:
C=(π×a⁴×P)/(8n×L) (1),
wherein C represents a conductance (m³/sec), a represents a radius of the tube, P represents an average pressure between two points, n represents a viscosity coefficient, and L represents a distance between the two points.

As a result, it has been experimentally confirmed that a vacuum performance is not affected by the surface roughness as described above.

The shape of the vacuum groove of the vacuum chuck may preferably be such a shape that a vacuum force is uniformly exerted on an objective mask. In this embodiment, the mask has a ring-like shape as shown in FIGS. 6 and 7 and a relatively light weight of 3 g, so that the groove of the vacuum chuck is designed to have a width of 1 mm.

In this embodiment, a clamping ability W of the vacuum force by the vacuum chuck is calculated according to the following equation (2):
W={(P×C)/101}×f×(10,13) (2),
wherein W represents a clamping ability, P represents a degree of vacuum, C represents a pad adsorption area, and f represents a coefficient of safety (=1/safety factor).

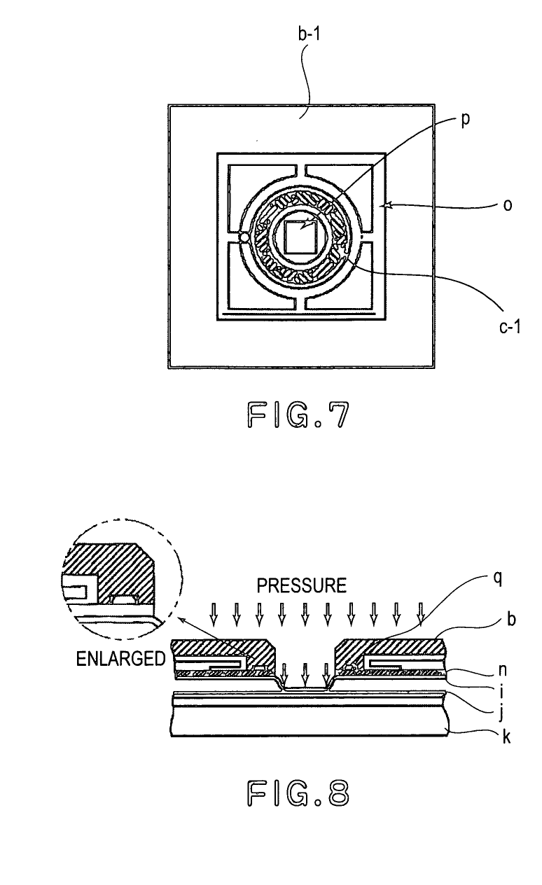

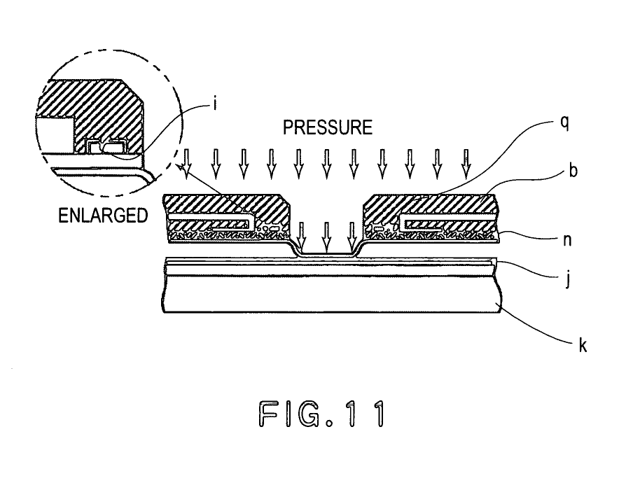

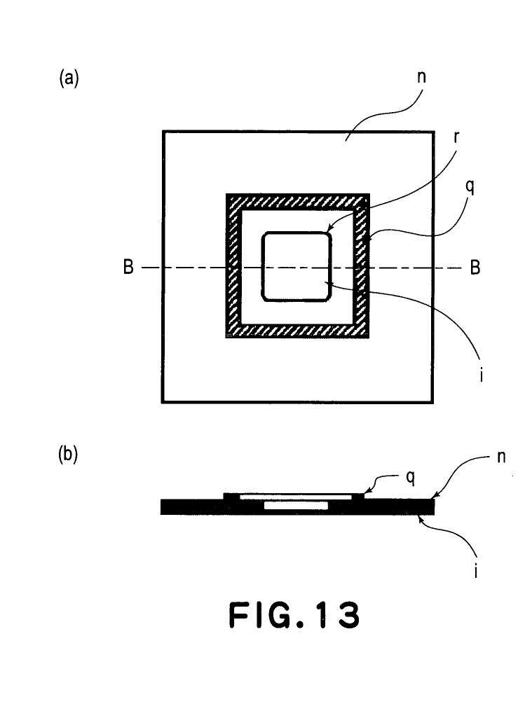

FIGS. 8 to 13 are views showing structures of sealing members or masks in an apparatus including a mask provided with a gasket in this embodiment. Of these figures, FIGS. 8 to 10 illustrate structures using the sealing members of a resin, a rubber, etc., and FIGS. 11 and 13 illustrate structures using the sealing members of a metal.

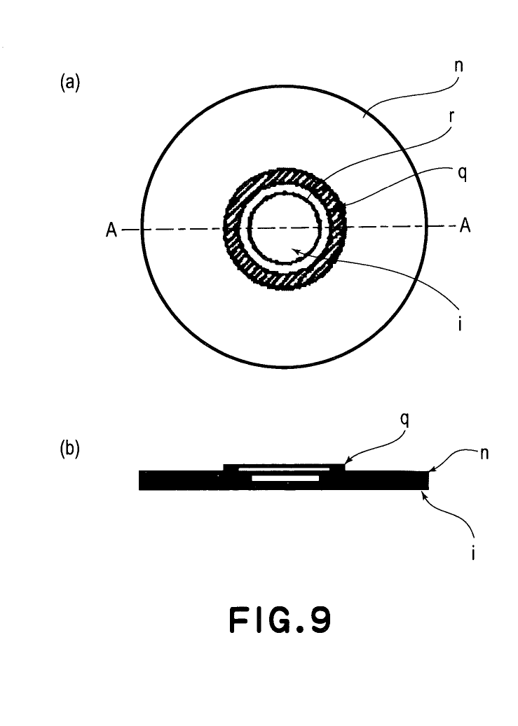

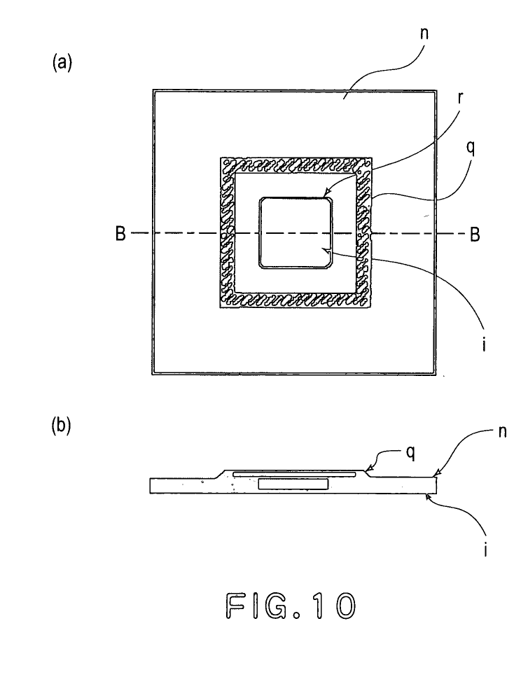

In the case of the sealing member of a resin, a rubber, etc., a mask provided with a gasket is prepared by integrally forming the sealing member, of a resin, a rubber, etc., for effecting sealing during application of pressure on the mask side so as to correspond to an opening of a circular-shaped pressure hole as shown in FIG. 9 or an opening of a rectangular-shaped pressure hole as shown in FIG. 10. By using such a mask with the gasket, when the mask is deformed by the pressure in the pressure adjusting vessel to be closely contacted to the resist, it becomes possible to suppress a fluctuation in pressure in the pressure adjusting vessel by the sealing member described above to be engaged in a mounting groove formed at the mask chuck surface as shown in FIG. 8.

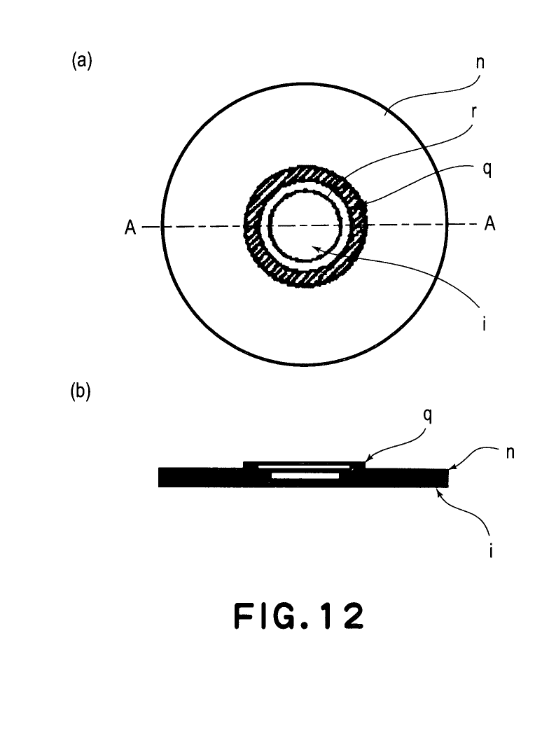

In the case of the sealing member of metal, a mask provided with a gasket is prepared by integrally forming the sealing member, of metal, for effecting sealing during application of pressure on the mask side so as to correspond to an opening of a circular-shaped pressure hole as shown in FIG. 12 or an opening of a rectangular-shaped pressure hole as shown in FIG. 13. By using such a mask with the gasket, when the mask is deformed by the pressure in the pressure adjusting vessel to be closely contacted to the resist as shown in FIG. 11, it becomes possible to suppress a fluctuation in pressure in the pressure adjusting vessel by the sealing member described above. In the case of the metal-made sealing member, it is necessary to provide a metal lip portion similar to a ConFlat Flange at a center position in a circumferential direction of the gasket on the mask chuck side.

Such a mask provided with the gasket is prepared by forming the sealing portion and the gasket portion at the same time during a process of preparing the mask substrate. These members can be formed through methods using photolithography, vapor deposition, dispenser, etc.

It is also considered that the mask with the gasket can be prepared by separately applying a sealing material and a gasket material onto a completed mask substrate. However, in view of contamination, flaw, etc., the above described method wherein the sealing portion and the gasket portion are formed at the same time during a process of preparing the mask substrate, may preferably be used.

In this embodiment, the vacuum-type supporting and fixing structure is employed as a specific example of the mask chuck applied to the exposure apparatus shown in FIG. 1 or 2, it may also be of other types including one of a magnet chuck-type as shown in FIG. 4 and one of an electrostatic chuck-type as shown in FIG. 5 so long as the resultant structure provides a mask clamping force which is fully resistance to a load condition such as a pressurizing force or a depressurizing force of the pressure adjusting vessel, similarly as in the case of the vacuum chuck described above.

[Embodiment 2]

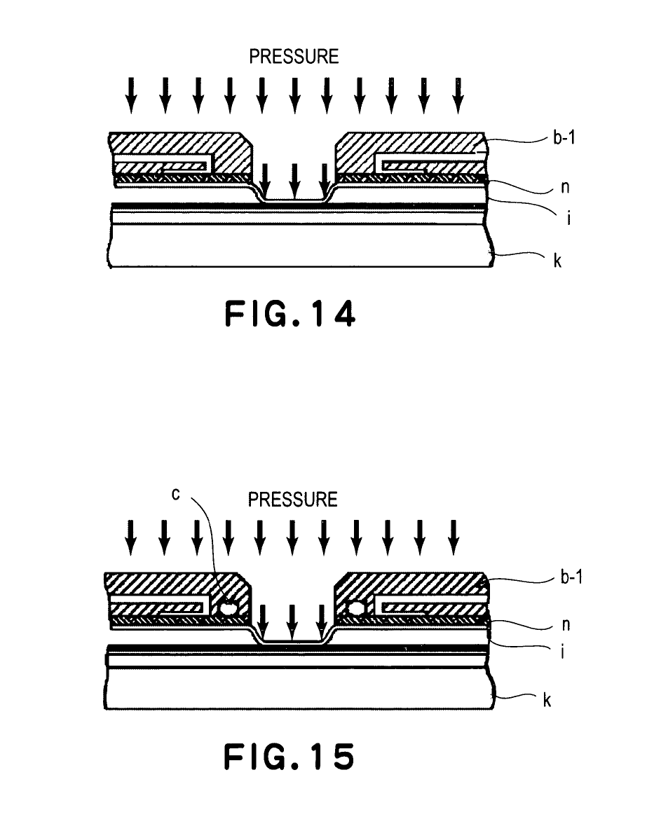

FIG. 14 shows a structure of a vacuum chuck in this embodiment according to the present invention.

The vacuum chuck in this embodiment has a structure identical to that of the vacuum chuck in Embodiment 1 except that the O-ring or the sealing member to be engaged in the mounting groove formed at the mask chuck surface is not provided.

In this Embodiment, a slight fluctuation in mask pressurizing pressure by the vacuum pressure during mask chucking is observed. However, the fluctuation is improved by further reducing the surface roughness of the vacuum chuck. More specifically, an accuracy of the surface roughness at the SUS surface is increased so as to provide a surface roughness of not more than 1.2 S (according to JIS B0601). As a result, with respect to a pressure of about 10-70 Pa required for close contact of the mask, the pressure fluctuation is improved to such an extent that an amount of leakage is of no problem in an about several minutes.

[Embodiment 3]

FIG. 15 shows a structure of a vacuum chuck in this embodiment according to the present invention.

The vacuum chuck in this embodiment has a structure identical to that of the vacuum chuck in Embodiment 1 except that the structure of the O-ring mounting groove formed at the mask chuck surface as shown in FIG. 3 in Embodiment 1 is changed to such a structure that an O-ring mounting groove is to be engaged with an O-ring which is separated from the mask and is disposed at a chucking portion. The O-ring is ordinarily damaged at its sealing surface by one or more times of replacement of the mask, thus causing pressure leakage. However, according to the present invention, the O-ring is disposed at the chucking portion to be easily replaced, thus effectively preventing the pressure leakage.

[Embodiment 4]

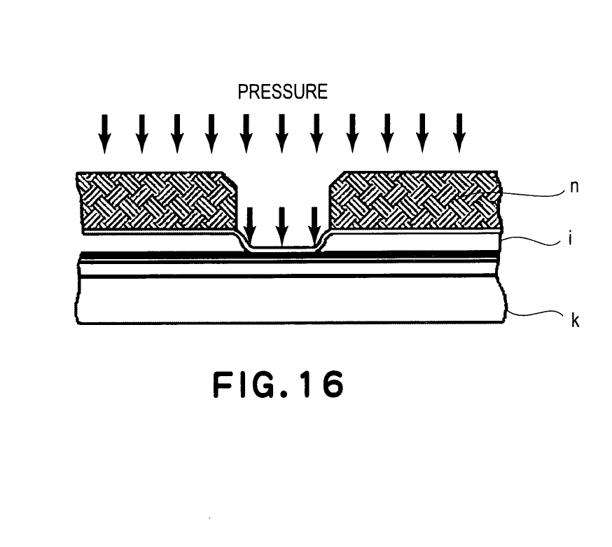

FIG. 16 shows a supporting and fixing structure for an near-field exposure mask in this embodiment according to the present invention.

In this embodiment, the mask and a pressure adjusting vessel as a pressurizing vessel or a depressurizing vessel are prepared by an integral sealing method.

According to this embodiment, the resultant structure can be integrally handled as a pressure adjusting vessel provided with the mask. Further, when the pressure is increased or decreased by the pressurizing vessel or the depressurizing vessel, it becomes possible to completely suppress a fluctuation in pressure in the pressurizing vessel or the depressurizing vessel. Accordingly, even in light exposure for a long time, it is possible to effect light exposure with no occurrence of the pressure fluctuation.

While the invention has been described with reference to the structures disclosed herein, it is not confined to the details set forth and this application is intended to cover such modifications or changes as may come within the purposes of the improvements or the scope of the following claims.

This application claims priority from Japanese Patent Application No. 321594/2003 filed Sep. 12, 2003, which is hereby incorporated by reference.

1. A near-field exposure apparatus, comprising:
an pressure adjusting vessel in which pressure is adjustable,
mask supporting means for supporting an elastically deformable exposure mask to said pressure adjusting vessel,
adjusting means for adjusting the pressure in said pressure adjusting vessel to bring the exposure mask into close contact with a substrate to be exposed to near-field light leaking from an opening provided in the exposure mask by irradiating the substrate with exposure light from a light source through the exposure mask, and
on-off control means for controlling said mask supporting means,
wherein a supporting force for supporting the exposure mask to said pressure adjusting vessel by said mask supporting means is resistant to a load created when the exposure mask is deformed by adjusting the pressure in the pressure adjusting vessel, and said mask supporting means is controlled by said on-off control means in an on-off control manner to permit the exposure mask to be mounted to and demounted from said pressure adjusting vessel.

2. An apparatus according to claim 1, wherein said supporting means supports the exposure mask by bringing a portion adjacent to the exposure mask into close contact with said supporting means.

3. An apparatus according to claim 2, wherein said supporting means supports the portion adjacent to vacuum chuck the exposure mask so that the exposure mask is elastically deformable at its center portion.

4. An apparatus according to claim 2, wherein said supporting means comprises a vacuum chuck.

5. An apparatus according to claim 4, wherein the vacuum chuck supports the exposure mask by disposing a sealing member between the exposure mask and the vacuum chuck.

6. An apparatus according to claim 4, wherein the vacuum chuck is provided with a groove for supporting the exposure mask to the vacuum chuck by evacuating a portion therebetween.

7. An apparatus according to claim 2, wherein said supporting means comprises a magnet.

8. An apparatus according to claim 2, wherein said supporting means comprises an electrostatic adsorption member.

9. An apparatus according to claim 1, wherein the exposure mask has a surface, located on the light source side, being disposed to face an inside of said pressure adjusting vessel.

10. An apparatus according to claim 1, wherein the exposure mask has a surface, located on the light source side, being disposed to face an outside of said pressure adjusting vessel.

11. An apparatus according to claim 1, wherein said on-off control means comprises a switch provided or connected to said supporting means so as to actuate an actuating portion of said supporting means.
